(19) United States
(12) Patent Application Publication
(10) Pub. No.: US 2023/0375067 A1
(43) Pub. Date: Nov. 23, 2023

(54) DEVICE FOR HOLDING AT LEAST TWO VALVES WITHIN A COMPONENT AND COMPONENT WITH THE DEVICE

(71) Applicant: Vibracoustic SE, Darmstadt, DE (US)

(72) Inventors: Marian Thies, Seevetal (DE); Oliver Langhof, Mölln (DE); Matthias Wolf, Lüneburg (DE); Christian Kuschel, Buchholz (DE)

(21) Appl. No.: 18/197,286

(22) Filed: May 15, 2023

(30) Foreign Application Priority Data
May 19, 2022 (DE) 102022112611.0

(51) Int. Cl. F16F 9/34; F16F 9/04

(52) U.S. Cl. CPC F16F 9/34; F16F 9/0454

(57) ABSTRACT

The disclosure relates to a device for holding at least two valves within a component, such as, for example, an air spring, an air suspension strut, or an air suspension damper. In embodiments, a may device comprise at least two fixing bodies fixedly connected to each other for fixing the valves in valve seats of the component and at least two securing elements fixedly connected to the fixing bodies for securing the device in an assembly position on the component. Thus, the disclosure may provide an improved device for holding valves in which the number of parts may be reduced and/or which may be inexpensive.

### CROSS-REFERENCE TO RELATED APPLICATION

This application claims priority to German Patent Application No. DE 10 2022 112 611.0, filed May 19, 2022, the contents of which are hereby incorporated by reference in its entirety.

### TECHNICAL FIELD

The invention relates to a device for holding at least two valves within a component and to a component with the device.

### BACKGROUND

For mounting valves in components, such as an air spring, an air suspension strut, or an air suspension damper, valve seats are provided in the components in which the valves are arranged during mounting. The valves can be inserted into the valve seats. The valves can be secured by means of retaining rings which lock between the valves and the components. The valves should also be secured in such a way that they cannot be replaced unnoticed by other manufacturers.

For this purpose, a retaining ring for a valve on a component is known, for example, from DE 10 2019 109 286 A1, which cannot be detached without being destroyed. The retaining ring engages in a circumferential groove of a component and forms an undercut there to prevent a valve from falling out. The ring itself is divided into two segments. After the first segment of the retaining ring has engaged in the groove, the second segment of the ring is inserted into the first segment, where it locks into place. The resulting positive locking cannot be released again without destroying the ring. If the retaining ring or the valve is dismantled, the destruction of the retaining ring can therefore prove that the valves have been replaced. This simplifies to check whether the valves have been replaced, especially whether they have been replaced by third-party products. To produce the grooves with an injection mold, folding cores are required in the injection mold.

### SUMMARY

The invention provides, inter alia, an improved device for holding valves in which the number of parts may be reduced and/or which may be inexpensive.

Various aspects and features of embodiments of the invention are disclosed herein.

The invention relates to a device for holding at least two valves within a component, such as, for example, an air spring, an air suspension strut, or an air suspension damper, wherein the device may comprise at least two fixing bodies fixedly connected to each other for fixing the valves in valve seats of the component and at least two securing elements fixedly connected to the fixing bodies for securing the device in an assembly position on the component.

The disclosure provides a device for holding at least two valves in a component. Instead of two or more retaining rings, only one device is required to hold at least two valves. The fixedly connected fixing bodies are connected to each other in such a way that they match the arrangement of the valves arranged in the valve seats. When the device is mounted on the valves arranged in the valve seats, all the valves intended to be fixed with the device are fixed simultaneously as soon as the device on the component changes to the assembly position. Furthermore, the securing elements secure the fixing bodies or the device to the component when the device is in the assembly position. The fixed connection of the fixing bodies to each other and the fixed connection of the securing elements to the fixing bodies provide a secure locking of the device to the component. The reduction of the number of parts by means of the invention simplifies the assembly of the valves. Furthermore, costs are saved in the manufacture of the device and in the assembly of the device.

Furthermore, circumferential grooves are not necessarily required on the component for the securing elements. Rather, simple slides in a plastic injection mold, for example, can be used to produce undercuts forming pockets, so that the use of folding cores can be dispensed with. It follows that the valve seats can be positioned closer together, so that installation space can be utilized more efficiently, or the design of the components is subject to fewer installation space restrictions.

According to an embodiment, at least one securing element can be arranged on each fixing body.

Thus, in embodiments, a securing element can be assigned to each fixing body. In this way, each fixing body can be directly secured to the component.

According to another embodiment, each fixing body can have at least one valve support surface for supporting a valve in a valve seat.

Each fixing body can thus directly support a valve in a valve seat. The number of fixing bodies may thus correspond to the number of valves to be held by the device.

Alternatively, a fixing body with several valve support surfaces can be provided. A fixing body configured in this way can thus support several valves on one valve support surface.

According to another embodiment, the valve support surfaces and the securing members may be arranged on opposite sides of the device.

Since, in the assembly position, the valve support surfaces are inserted into the component first, the securing elements are inserted into the component after the valve support surfaces. The valve support surfaces thus do not block the view on the securing elements.

According to one embodiment, at least one fixing body may have a partial cylindrical shape.

For this purpose, the fixing body may extend along a cylinder axis, for example. Further, a wall of the fixation body can be formed as a partial cylinder jacket, which extends as a partial rotation body partially around the cylinder axis. This shape is particularly advantageous if the valve seats can be accessed via a round opening. The openings provided for inserting the valves into the component can simply be provided by bores or round cores, then. In this context, it is particularly advantageous if the part-cylinder mold has slight draft angles in the direction of the cylinder axis, for example at an end region of the part-cylinder mold. This facilitates production of the fixing bodies by means of plastic injection molding on the one hand and assembly on the other. However, this does not exclude the possibility that the openings and the fixing bodies have an angular basic cross section.

It is further conceivable, for example, that at least one securing element can have a latching element, which may be directed outwards, and which may be configurded as a lug with a latching nose. In embodiments having a lug, the lug may be configured bent at least uniaxially starting from a latching nose.

The securing element may then latches onto the component, so that the assembly may be further simplified and an acoustic feedback may be provided, if necessary, about the secure assembly of the device to the component. A provided tab may increase the spring action of the latch. If the tab is further configured to be at least uniaxially bent, the tab can be provided as an extension of a part-cylindrical fixing body. Thereby, the manufacturing of the device may be further simplified.

According to another embodiment, the device may comprise at least one through hole for passing at least one valve connector therethrough.

The valves held in the component by the device can thus be easily connected to conduits, such as hoses or cables, through the through-opening. In another embodiment, the through opening may additionally extend through the fixing body. Further, the device may have a single through opening extending through all of the fixing bodies. Alternatively, each fixing body may have its own through-opening.

For example, the fixation bodies may be formed as walls of the at least one through-opening, wherein the at least one through-opening extends through the fixation bodies.

The fixing bodies can then be formed only as walls and support the valves only at one edge of the valves in the valve seats. In this way, material can be saved in the manufacture of the device.

For example, the device may have a base body extending along a longitudinal axis, wherein the fixing bodies are connected to the base body in a direction transverse to the longitudinal axis and may extend parallel offset to the longitudinal axis and parallel offset to each other.

The fixing bodies may be attached to the base body. The base body may form a base of the device from which the fixing bodies extend away. The position of the fixing bodies relative to each other and relative to the base body is configured to correspond to the arrangement of the valve seats in the component.

According to one embodiment, the base body can be formed as a press-fit socket.

For this purpose, the base body can project over the fixing bodies on one side so that the fixing bodies can be inserted deeper into the component than the base body. The base body can thus function as an operating body for mounting the device in the component.

Further, the invention relates to a component, such as an air spring, an air spring strut or an air spring damper, having at least one opening in which at least two valve seats are arranged, at least two valves which are inserted into the valve seats, and at least one device according to the preceding description, wherein the device is inserted in an assembly position on the component in the opening and holds the valves in the valve seats, wherein, for each securing element, the component has a counter element for connection to the respective securing element and the securing elements cannot be detached from the counter elements through the opening at least without damage.

The device can be inserted into the component through the opening to retain valves in the valve seats. By means of the mating elements on the component, the securing elements can secure the device to the component. Furthermore, because the securing elements cannot be detached from the mating elements through the opening without causing damage, an unnoticed replacement of the valves is avoided. The securing elements can only be accessible through the opening when the device is in the assembly position on the component. Further advantages and effects as well as further developments of the component result from the advantages and effects as well as further developments of the device described above. Reference is therefore made in this respect to the preceding description.

According to one embodiment, the counter element and the securing element may be positively connected in a direction out of the opening.

The tight connection between the securing element and the at least one fixing body also provides a positive fit for the device in a direction out of the opening. This also provides a simple way of securing the device in the component.

Further, the mating element may, for example, comprise a pocket for receiving at least a portion of a securing element, the mating element preferably being disposed in a wall of the opening.

The securing element may then, for example, be resiliently formed towards the outside and engage in the counter element. For assembly, the device can be pushed into the opening without much effort. As soon as the assembly position is reached, securing is effected automatically by locking the securing elements in the pockets.

Further features, details and advantages of the invention will be apparent from the wording of the claims and from the following description of embodiments with reference to the drawings. The drawings show with

### BRIEF DESCRIPTION OF THE DRAWINGS

FIGS. 1a and 1b generally illustrate a schematic representation of a device for holding at least two valves; and

FIG. 2 generally illustrates a schematic representation of a component with the device.

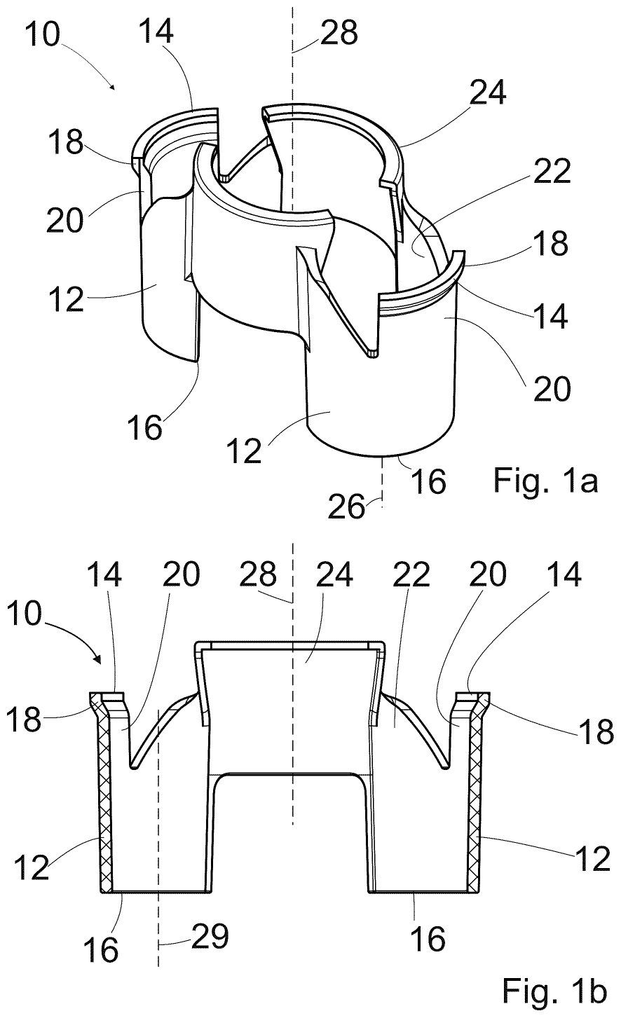

In FIG. 1a, the device for holding at least two valves is referenced in its entirety by reference numeral 10.

### DETAILED DESCRIPTION

In the illustrated embodiment, the device 10 is configured for holding two valves. For this purpose, the device 10 has two fixing bodies 12. In an embodiment in which the device 10 holds more than two valves, the device 10 may have more than two fixing bodies 12, the number of fixing bodies 12 may correspond to the number of valves to be held.

In the following, one fixing body 12 will be described. The explanations regarding the described fixing body 12 can be applied analogously to further fixing bodies 12 of the device 10.

The fixing body 12 is configured to hold at least one valve on a component. For this purpose, the fixing body 12 may have at least one valve support surface 16, which in this embodiment is arranged at the lower edge of the fixing body 12. The fixing body 12 may be used to provide a positive fit for the valve in a disassembly direction of the valve. The disassembly direction refers to the direction in which the valve is removed from the valve seat of the component.

The fixing body 12 may further have a partial cylindrical shape. In this regard, the fixing body 12 may extend along a cylinder axis 26, extending only partially around the cylinder axis 26.

Further, the fixing body 12 may extend as a wall around a through opening 22 of the device 10. In FIG. 1a, the passage opening 22 extends from an upper edge of the device 10 to a lower edge of the device 10. Through the passage opening 22, a valve connection can be made from the upper edge of the device 10 to the lower edge of the device 10, such as at the fixing body 12.

The fixing bodies 12 are fixedly connected to each other, so that they have a fixed positional relationship to each other. The positional relationship of the fixing bodies 12 to each other is determined by the position of the valve seats in the component, at which the device 10 is to hold the valves.

The device 10 may further comprise a base body 24, which provides the fixed connection between the fixing bodies 12. For this purpose, the fixing bodies 12 may be fixedly connected to the base body 24. Further, the base body 24 can be configured as a press-fit socket. For this purpose, the base body 24 can project over the fixing bodies 12. The press-fit socket can facilitate insertion of the device 10 into a component for mounting the device 10. To this end, for example, a user may hold the device 10 by the press-fit socket and insert it into the component to hold valves disposed in the component in their valve seats on the component.

The through opening 22 may extend through the base body 24 and the locating bodies 12. Thus, the device 10 may comprise only a wall extending around the through-opening 22 and forming the base body 24 and the fixing bodies 12.

Further, the device 10 comprises at least two securing elements 14. In this embodiment, the device 10 is shown with two securing elements 14. However, the number may be greater, and the number of securing elements 14 may correspond to the number of fixing bodies 12 or valve seats on the component.

In the following, one securing element 14 will be described. The explanations for the described securing element 14 can be applied analogously to further securing elements 14 of the device 10.

The securing element 14 can be attached to the fixing body 12. Further, each fixing body 12 can have a securing element 14.

Further, the securing element 14 is arranged on a side of the fixing body 12 opposite the valve support surfaces 16 on the device 10.

The securing element 14 may include a latching element 18 formed as an outwardly directed latching tab attached to a free end of a tab 20. The tab 20 may be configured to be resilient. When the latching lug is pressed into the through opening 22, the tab 20 causes a spring force to counteract the compressive force. If the compressive force is removed, the latching lug is pressed outward by the spring force of the tab 20.

The tab 20 and the latching element 18 as a whole can be formed bent about the cylinder axis 26. In this case, the lug 20 can protrude upwards from the wall of the fixing body 12 and be formed as an extension of the wall of the fixing body 12.

This is illustrated by FIG. 1b showing a longitudinal sectional view of the device 10.

The securing element 14 may extend in a circumferential direction around the cylinder axis 26 by a maximum of 120° and may be formed in a circular arc around the cylinder axis 26 in this direction. At the same time, the securing element 14 also extends in a circumferential direction about the longitudinal axis 28 by a maximum of 90° about the longitudinal axis 28.

The device 10 may be formed from a single piece, for example as a plastic injection molded part.

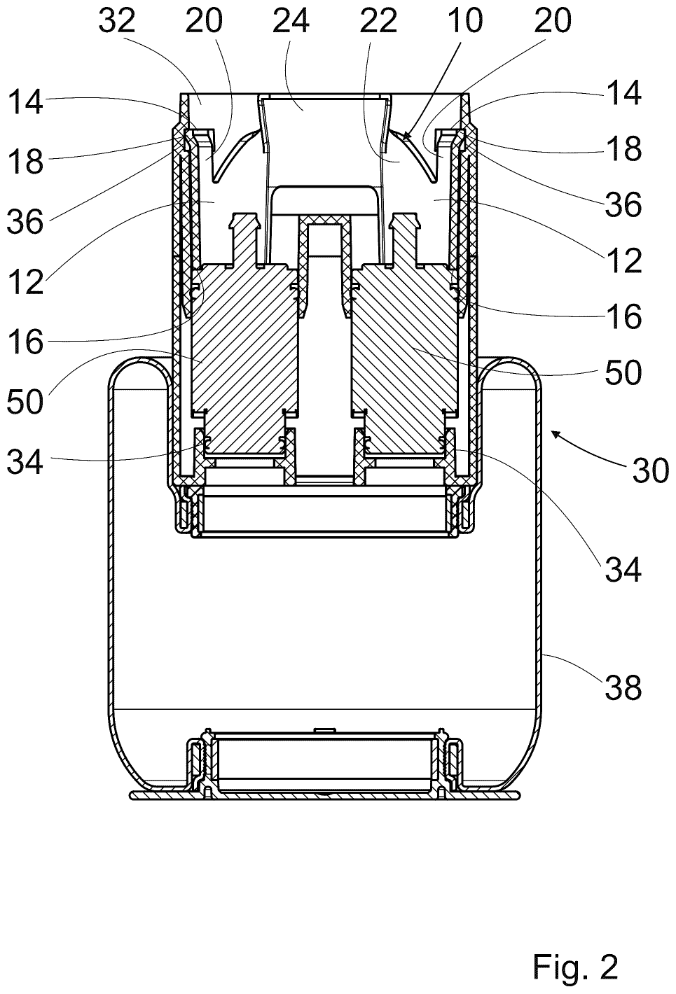

FIG. 2 shows a sectional view of a component, which in this embodiment is formed as an air spring and is referenced in its entirety by the reference numeral 30.

The component 30 has an opening 32 in which, in this embodiment, two, valve seats 34 are arranged. The valve seats 34 may be arranged at an orifice of a bellows 38, as the component 30 is configured as an air spring in this embodiment.

Further, the component 30 has valves 50 that may be configured to control the amount of air or to control air flows within the component 30. The valves 50 may be disposed through the opening 32 in the valve seats 34. In this regard, the valves 50 are connected to an end portion in the valve seats 34.

The device 10 can be inserted through the opening 32 after positioning the valves 50 in the valve seats 34. The device 10 can be pressed onto the valves 50 via the base body 24, which is configured as a press-fit socket. The fixing bodies 12 form a positive fit in a direction out of the opening with respect to the valves 50, so that the valves 50 are held in the valve seats 34 by the fixing bodies 12.

The component 30 further includes counter elements 36 for the securing elements 14. The counter elements 36 may be disposed on a wall of the opening 32, wherein each counter element 36 is configured to connect to a securing element 14. The connection between a securing element 14 and a corresponding counter element 36 may be configured to form a positive fit in a direction out of the opening 32. For this purpose, the counter elements 36 may be formed as pockets on the wall of the opening 32.

The pockets of the mating elements 36 extend on the wall of the opening 32 around the opening 32 only around a portion of the circumference of opening aperture 32. In this regard, the extent of a pocket is only required to correspond to the extent of the securing element 14 associated with the pocket. In embodiments, no pockets or grooves are required which extend around the entire opening 32. This can simplify the manufacture of the counter elements 36.

These pockets can be produced in the opening 32 with little effort by means of cores with inclined slides if the component of the component 30 to which the opening 32 is arranged is a casting, such as a plastic injection molding.

The pockets of the mating elements 36 can form undercuts in a direction out of the opening 32, against which the securing elements 14 can be placed.

When the device 10 holds the valves 50 against the valve seats 34 in an assembly position, the securing elements 14 can engage with the corresponding counter elements 36. The interlocking between the securing elements 14 and the mating elements 36 then prevents the device 10 from moving out of the opening 32.

The locking of the securing elements 14 to the counter elements 36 is configured in such a way that it is not possible to detach the securing elements 14 from the counter elements 36 through the opening 32 without causing damage. For this purpose, for example, no gap accessible through the opening 32 can be arranged between the securing elements 14 and the counter elements 36. This prevents the securing elements 14 from being levered out of the counter elements 36 without causing damage, to release the connection between the securing elements 14 and the counter elements 36.

If the securing elements 14 are formed as latching elements 18, the securing elements 14 can automatically latch with the counter elements 36 when the device 10 is arranged in the assembly position.

Via the through opening 22, valve connections in the form of hoses can be supplied to the valves 50 to connect the valves 50 in a fluid-communicating manner, for example to an air reservoir. Complementarily or alternatively, cables can be fed to the valves 50 via the through-opening 22 to control them.

Thus, only one device 10 is required to hold the valves 50 in the component 30.

The invention is not limited to any of the above-described embodiments but can be varied in a variety of ways, including those known to those of skill in the art.

All the features and advantages, including constructional details, spatial arrangements and procedural steps, which emerge from the claims, the description and the drawing, can be employed with the invention both individually and in a wide variety of combinations.

1. A device for holding at least two valves within a component, the device comprising:
at least two fixing bodies, the at least two fixing bodies fixedly connected to one another, and configured to fix the at least two valves in valve seats of the component; and
at least two securing elements that are fixedly connected to the fixing bodies and are configured to secure the device in an assembly position on the component.

2. The device according to claim 1, wherein the component is an air spring, an air suspension strut, or an air suspension damper.

3. A device according to claim 1, wherein at least one securing element of the at least two securing elements is arranged on each fixing body of the at least two fixing bodies.

4. A device according to claim 1, wherein each fixing body of the at least two fixing bodies has at least one valve support surface to support a valve in a valve seat.

5. A device according to claim 4, wherein the valve support surfaces and the securing elements are arranged on opposite sides of the device.

6. A device according to claim 1, wherein at least one fixing body has a partial cylindrical shape.

7. A device according to claim 1, wherein at least one securing element has a latching element.

8. A device according to claim 7, wherein the latching element of the at least one securing element is directed outwards and is configured as a lug with a latching lug.

9. A device according to claim 8, wherein, the lug is configured bent at least uniaxially starting from the latching lug.

10. A device according to claim 1, wherein the device has at least one through-opening for passage of at least one valve connection.

11. A device according to claim 10, wherein the fixing bodies are formed as walls of the at least one through-opening, and the at least one through-opening extends through the fixing bodies.

12. A device according to claim 1, wherein the device has a base body that extends along a longitudinal axis, the fixing bodies are connected to the base body in a direction transverse to the longitudinal axis.

13. The device according to claim 12, wherein the fixing bodies extend parallel offset to the longitudinal axis and parallel offset to each other.

14. A device according to claim 12, wherein the base body is configured as a press-fit socket.

15. A component, the component comprising at least one opening in which at least two valve seats are provided, at least two valves are inserted into the valve seats, and at least one device according to claim 1, wherein the device is inserted in an assembly position on the component in the opening and holds or retains the valves in the valve seats, wherein the component has, for each securing element, a counter-element for connection to the respective securing element and the securing elements cannot be detached from the counter-elements through the opening without damage.

16. The component of claim 15, wherein the component comprises an air spring, an air spring strut, or an air spring damper.

17. The component according to claim 15, wherein the counter element and the securing element are positively connected in a direction out of the opening.

18. The component according to claim 15, wherein the counter element comprises a pocket for receiving at least part of a securing element.

19. The component according to claim 15, wherein the counter element is provided in a wall of the opening).
